(19) United States
(12) Patent Application Publication
(10) Pub. No.: US 2023/0187786 A1
(43) Pub. Date: Jun. 15, 2023

(54) BATTERY MODULE MANUFACTURING METHOD AND LASER WELDING METHOD USING FILLER WIRE

(71) Applicant: HYUNDAI MOBIS CO., LTD., Seoul (KR)

(72) Inventor: Dong Kyu KIM, Yongin-si (KR)

(73) Assignee: HYUNDAI MOBIS CO., LTD., Seoul (KR)

(21) Appl. No.: 17/939,349

(22) Filed: Sep. 7, 2022

(30) Foreign Application Priority Data
Dec. 14, 2021 (KR) 10-2021-0178502

(51) Int. Cl. H01M 50/505; H01M 50/20; H01M 50/516

(52) U.S. Cl. CPC H01M 50/505; H01M 50/20; H01M 50/516

(57) ABSTRACT

Disclosed is a battery module manufacturing method for welding a busbar and an electrode lead included in a battery cell. The method includes bonding the busbar and a filler wire by laser welding. The method also includes bonding the electrode lead and the filler wire by laser welding after the bonding the busbar and the filler wire.

### CROSS-REFERENCE TO RELATED APPLICATIONS

This application claims the benefit under 35 USC § 119(a) of Korean Patent Application No. 10-2021-0178502, filed on Dec. 14, 2021, in the Korean Intellectual Property Office, the entire disclosure of which is incorporated herein by reference for all purposes.

### BACKGROUND

### 1. Field

The present disclosure relates to a battery module manufacturing method and a laser welding method using a filler wire.

### 2. Description of Related Art

Generally, battery cells and busbars of a battery module are bonded by lap welding. For example, laser welding using a laser beam may be used to bond battery cells and busbars or a battery module.

When the busbars and the battery cells are lap welded by using a laser, whether the laser infiltrates into the battery cells affects the stability and performance of the battery cells. However, because performance degradation due to the infiltration of the laser occurs after a predetermined period of time, it is difficult to detect an initial defect. Furthermore, it is necessary to increase the amount of penetration for high-strength welding. However, it is difficult to check how much penetration is made during welding, and due to this, a problem of infiltration of the laser into the battery cells may occur.

In addition, when the lap welding is performed by a laser, if there is no gap between the battery cells and the busbars or a gap is not maintained constant, the laser may pass through the battery cells and may reach the insides thereof. In these instances, the performance of a battery pack may be deteriorated. Accordingly, it is necessary to improve a technology capable of stably welding busbars and battery cells in manufacture of a battery module.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, here is provided method of manufacturing a battery module including a busbar and an electrode lead included in a battery cell. The method includes bonding the busbar and a filler wire by laser welding, and bonding the electrode lead included in the battery cell and the filler wire by laser welding after bonding the busbar and the filler wire.

The busbar and the electrode lead included in the battery cell may be formed of different metallic materials, and the filler wire may be formed of a material different from those of the busbar and the electrode lead.

The method may include, prior to bonding the busbar and the filler wire, preparing the busbar with at least one insertion hole formed in the busbar. The method may also include superposing the busbar on the electrode lead included in the battery cell, and supplying the filler wire such that the filler wire is inserted into the at least one insertion hole.

Preparing the busbar may further include forming the at least one insertion hole in an area in which the busbar and the battery cell overlap each other, and forming the at least one insertion hole in the busbar to extend in a first direction. The at least one insertion hole in this instance includes a plurality of insertion holes formed spaced apart from each other in a second direction crossing the first direction.

Supplying the filler wire may further include supplying the filler wire to extend in the first direction, and forming a diameter of a cross-section of the filler wire in a direction perpendicular to the first direction to be equal to a size of the insertion hole in the second direction within a machining error range.

In bonding the busbar and the filler wire, the laser welding may be performed such that opposite lateral portions of the filler wire in the second direction are bonded to the busbar.

In at least one of bonding the busbar and the filler wire and bonding the electrode lead and the filler wire, a laser beam may be applied at different angles multiple times.

In at least one of bonding the busbar and the filler wire and bonding the electrode lead and the filler wire, the welding may be performed in an oblique state in which an angle at which the laser beam is applied has a predetermined angle with a direction in which the electrode lead and the busbar are spaced apart from each other.

In another general aspect, here is provided a battery module manufacturing method for welding an upper plate and a lower plate. The method includes bonding the upper plate and a filler wire by laser welding. The method also includes bonding the lower plate and the filler wire by laser welding after bonding the upper plate and the filler wire.

Other features and aspects will be apparent from the following detailed description, the drawings, and the claims.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic view illustrating a state in which battery cells and busbars of a battery module applied to an embodiment of the present disclosure overlap each other;

FIG. 2 is a top view of the battery module of FIG. 1, where FIG. 2 illustrates the state in which the battery cells and the busbars of the battery module applied to the embodiment of the present disclosure overlap each other;

FIG. 3 is a view illustrating a state in which filler wires are inserted into insertion holes of the busbars applied to the embodiment of the present disclosure;

FIG. 4 illustrates a state in which the filler wire is inserted into the insertion hole of the bus bar in the battery module applied to the embodiment of the present disclosure, where FIG. 4 is a sectional view in a direction perpendicular to a first direction in FIG. 3;

FIG. 5 is a view illustrating a first welding step according to an embodiment of the present disclosure;

FIG. 6 is a view illustrating a second welding step according to an embodiment of the present disclosure;

FIGS. 7A and 7B are a view for describing one example that a laser beam is obliquely applied to both lateral portions of the filler wire in the second direction D2, respectively, in the first welding step according to an embodiment of the present disclosure; and

FIGS. 8A and 8B are views illustrating one example that laser beams are applied at different angles θ1 and θ2 in the first welding step according to an embodiment of the present disclosure.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

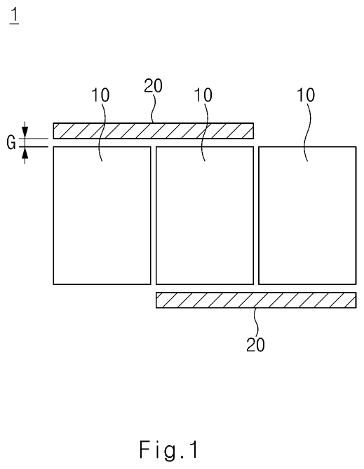

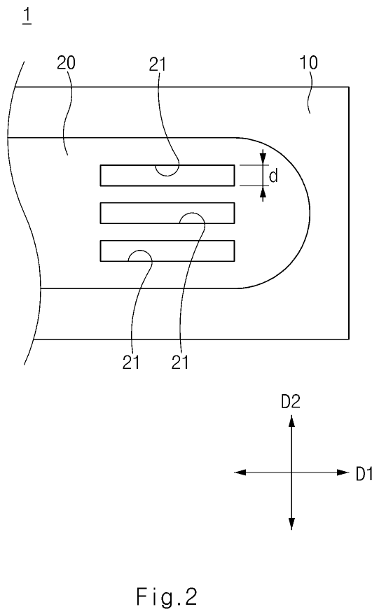

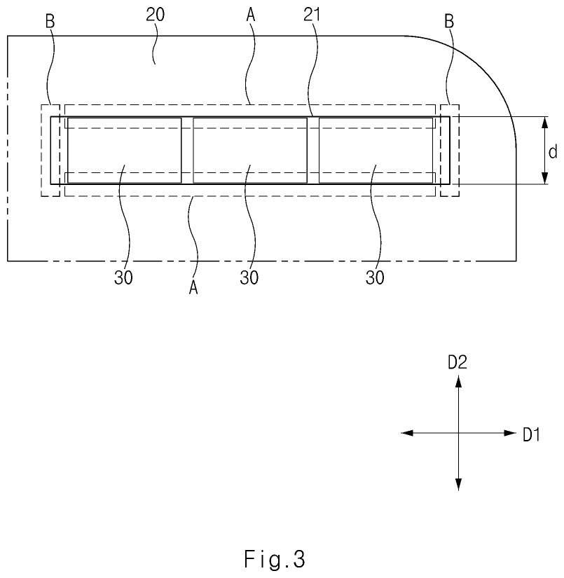

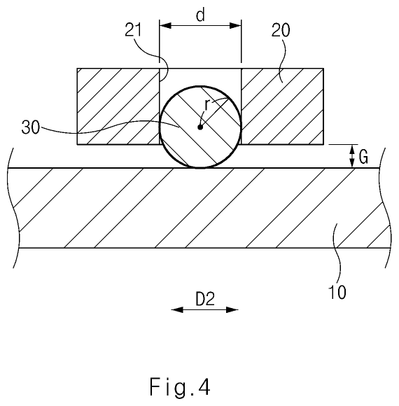

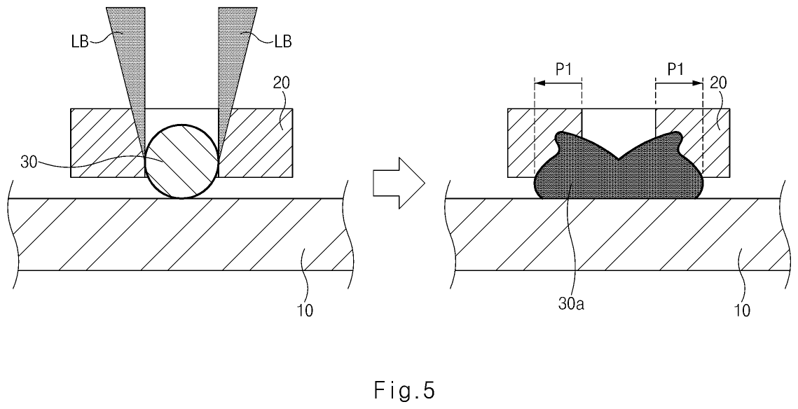

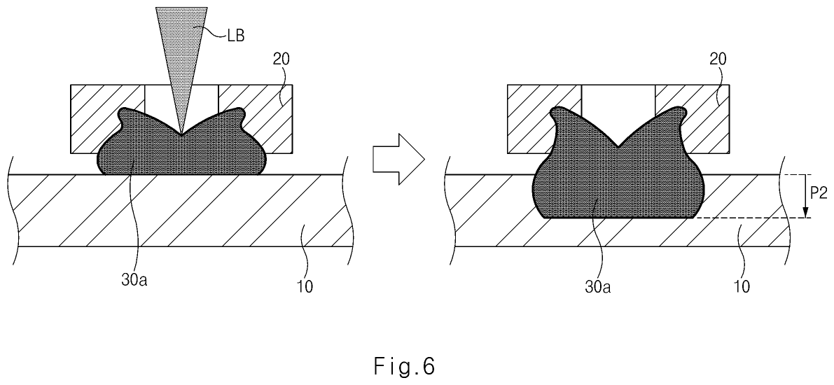

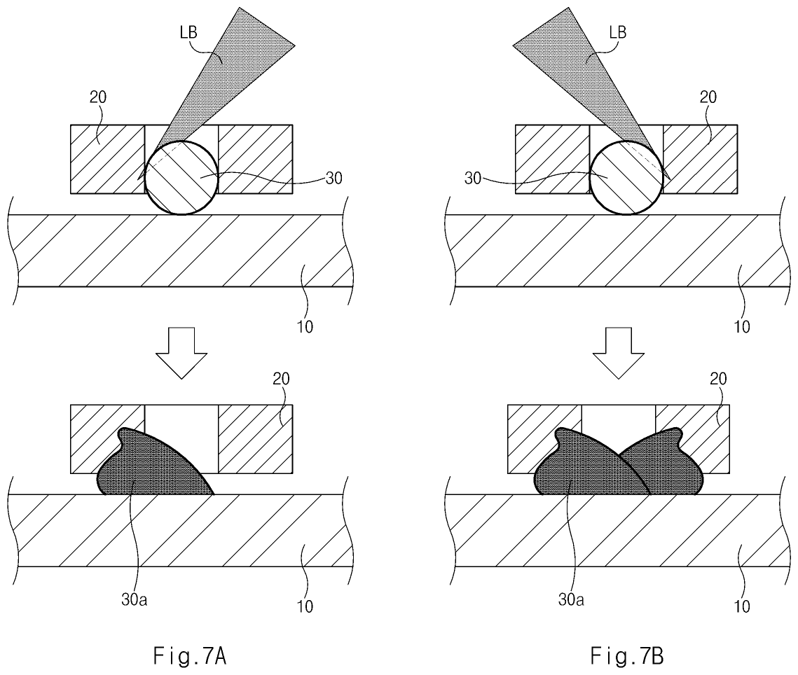

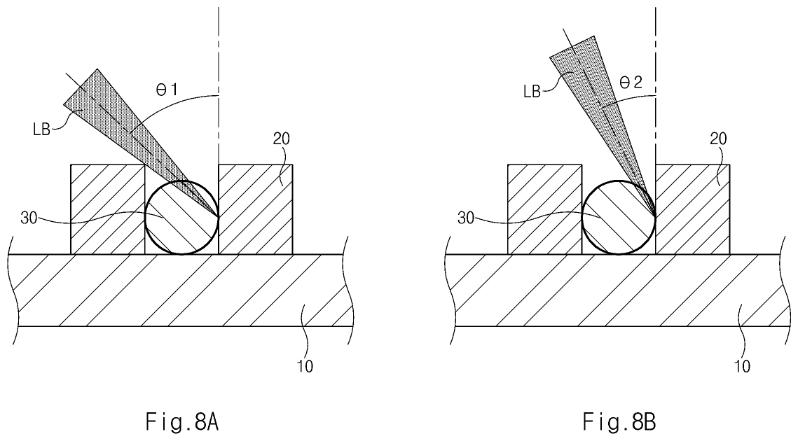

FIG. 1 is a schematic view illustrating a state in which battery cells and busbars of a battery module applied to an embodiment of the present disclosure overlap each other; FIG. 2 is a top view of the battery module of FIG. 1, where FIG. 2 illustrates the state in which the battery cells and the busbars of the battery module applied to the embodiment of the present disclosure overlap each other. FIG. 3 is a view illustrating a state in which filler wires are inserted into insertion holes of the busbars applied to the embodiment of the present disclosure. FIG. 4 illustrates a state in which the filler wire is inserted into the insertion hole of the bus bar in the battery module applied to the embodiment of the present disclosure, where FIG. 4 is a sectional view in a direction perpendicular to a first direction in FIG. 3. FIG. 5 is a view illustrating a first welding step according to an embodiment of the present disclosure. FIG. 6 is a view illustrating a second welding step according to an embodiment of the present disclosure. FIGS. 7A and 7B are a view for describing one example that a laser beam is obliquely applied in the first welding step according to an embodiment of the present disclosure. FIGS. 8A and 8B are views illustrating one example that laser beams are applied at different angles in the first welding step according to an embodiment of the present disclosure.

Referring to FIGS. 1 to 8B, an embodiment of the present disclosure relates to a battery module manufacturing method of welding the busbars 20 and electrode leads included in the battery cells 10 using the filler wires 30.

The battery module manufacturing method according to an embodiment of the present disclosure includes the first welding step of bonding the busbars 20 and the filler wires 30 by laser welding and the second welding step of bonding the electrode leads included in the battery cells 10 and the filler wires 30 by laser welding after the first welding step.

The busbars 20 and the electrode leads included in the battery cells 10 may be formed of different metallic materials. The filler wires 30 may be formed of a material different from the material of the busbars 20 and the material of the electrode leads included in the battery cells 10.

The battery module manufacturing method may further include, prior to the first welding step, a busbar preparing step of preparing the busbars 20 having the insertion holes 21 formed therein, a superposing step of superposing the busbars 20 on the electrode leads included in the battery cells 10, and a filler wire supply step of supplying the filler wires 30 such that the filler wires 30 are inserted into the insertion holes 21.

In the busbar preparing step, the insertion holes 21 may be formed in the areas in which the busbars 20 and the battery cells 10 overlap each other and may be formed in the busbars 20 to extend in the first direction D1. The insertion holes 21 may be spaced apart from each other in a second direction D2 crossing the first direction D1.

Hereinafter, embodiments of the present disclosure will be described in detail with reference to the accompanying drawings.

The battery module manufacturing method according to the present disclosure is a method for electrically connecting the busbars 20 of the battery module 1 and the electrode leads of the battery cells 10 by bonding the busbars 20 and the electrode leads.

For example, the battery cells 10 applied to the present disclosure may be formed in a cylindrical shape, and the electrode leads may be formed at opposite ends of the cylindrical battery cells 10 in the lengthwise direction. The busbars 20 may serve to electrically connect the electrode leads of the battery cells 10. That is, the busbars 20 may make contact with upper ends and lower ends of the battery cells 10 to connect the upper ends of the battery cells 10 and connect the lower ends of the battery cells 10. However, the shape of the battery cells 10 and the contact positions of the busbars 20 are not limited thereto.

The busbar preparing step is a step of preparing the busbars 20 having the insertion holes 21 formed therein. More specifically, in the busbar preparing step, the insertion holes 21 are previously formed in the busbars 20.

In the busbar preparing step, the insertion holes 21 may be formed in the areas in which the busbars 20 and the electrode leads included in the battery cells 10 overlap each other and may be formed in the busbars 20 to extend in the first direction D1. The insertion holes 21 may be spaced apart from each other in the second direction D2 crossing the first direction D1.

The insertion holes 21 may be formed to be long in the first direction D1 that is one direction on the busbars 20. One insertion hole 21 may be provided, or a plurality of insertion holes 21 may be provided so as to be spaced apart from each other by a predetermined gap in the second direction D2. The length and number of insertion holes 21 are not limited and may be diversely changed depending on design specifications. For example, the second direction D2 may be a direction perpendicular to the first direction D1, but is not limited thereto.

The superposing step is a step of superposing the busbars 20 on the electrode leads included in the battery cells 10. Specifically, the superposing step may be a step of arranging the busbars 20 and the electrode leads of the battery cells 10 such that the busbars 20 and the electrode leads of the battery cells 10 overlap each other, and the busbars 20 may overlap the electrode leads provided in the upper and lower end portions of the battery cells 10.

The filler wire supply step is a step of supplying the filler wires 30 such that the filler wires 30 are inserted into the insertion holes 21.

The filler wires 30 include filler metal and welding wires and are metals added to form joints through welding. In the case of welding between materials that do not react with each other or in the case of adjusting heat capacity during the welding, the welding may be performed by additionally applying materials capable of reacting with two materials to be bonded, and the additional materials may be the filler wires 30.

For example, the busbars 20 and the electrode leads included in the battery cells 10 may be formed of different metallic materials. The filler wires 30, the busbars 20, and the electrode leads included in the battery cells 10 may be formed of different materials.

For example, the busbars 20 may be formed of copper (Cu), and the electrode leads of the battery cells 10 may be formed of iron (Fe). In this case, the filler wires 30 may be formed of nickel or a nickel alloy. Because a nickel material forms a solid solution with iron and forms a metal compound with copper, the nickel material may form a welding portion having reliability and good weldability when used as the filler wires 30. However, the material of the filler wires 30 is not limited thereto, and various materials may be applied as long as the busbars 20 and the electrode leads of the battery cells 10 are able to be welded.

In the filler wire supply step, the filler wires 30 may be supplied so as to be inserted into the insertion holes 21 of the busbars 20. For example, the filler wires 30 may be supplied to extend in the first direction D1 and may be spaced apart from each other. In the first direction D1, the filler wires 30 may have a length sufficient to secure appropriate strength after welding.

The first welding step and the second welding step are steps of bonding the busbars 20 and the filler wires 30 by laser welding and bonding the filler wires 30 and the electrode leads of the battery cells 10 by laser welding.

Specifically, in the first welding step and the second welding step, the filler wires 30 may be welded with the busbars 20 and the electrode leads of the battery cells 10 by using laser welding. A deficiency in strength and a breakdown due to high brittleness that occur in existing butt joint welding or overlap joint welding may be improved by bonding the filler wires 30 and the busbars 20 by laser welding and bonding the filler wires 30 and the electrode leads by laser welding in the state in which the filler wires 30 are inserted into the insertion holes 21 formed through the busbars 20.

Specifically, by performing laser welding in the state in which the insertion holes 21 are previously formed in the busbars 20 and the filler wires 30 are inserted into the insertion holes 21, infiltration of laser beams LB into the electrode leads of the battery cells 10 may be minimized, and the depth of penetration may be sufficiently secured. In addition, by performing welding using the filler wires 30, occurrence of predetermined gaps G between the busbars 20 and the battery cells 10 may be absorbed, and thus welding quality may be maintained constant even without management of the gaps G.

The first welding step is a step of bonding the busbars 20 and the filler wires 30 by laser welding (refer to FIG. 5). The second welding step is a step of bonding the electrode leads included in the battery cells 10 and the filler wires 30 by laser welding after the first welding step (refer to FIG. 6).

That is, the battery module manufacturing method according to an embodiment of the present disclosure is characterized by performing the welding process in two steps. This is because the busbars 20 and the electrode leads of the battery cells 10 are formed of different materials and the filler wires 30 are formed of a material different from the materials of the busbars 20 and the electrode leads as described above so that it is difficult to find an appropriate welding condition for welding the busbars 20, the electrode leads, and the filler wires 30 at one time. Furthermore, even when the welding condition is found, a welding portion may be out of an area that can be welded by laser welding, or a defect in welding may occur due to excessive heat input. Accordingly, in an embodiment of the present disclosure, the two-step welding process is performed for workability and welding quality.

Specifically, in the first welding step, laser beams LB may be applied to the areas between the opposite lateral portions of the filler wire 30 in the second direction D2 and the busbar 20. At this time, the first welding step is performed in consideration of welding conditions, such as the melting points of the filler wire 30 and the busbar 20 and the arrangement state thereof.

In the first welding step, a filler wire 30a melted by welding may penetrate into the busbar 20 to a predetermined depth (refer to P1 of FIG. 5). Accordingly, the adhesion between the busbar 20 and the filler wire 30 may be strengthened. In this specification, the filler wire before the melting is assigned with reference numeral 30, and the filler wire after the melting is assigned with reference numeral 30a.

In the second welding step, a laser beam LB may be applied to the central area of the filler wire 30a, which is firstly melted in the first welding step, based on the second direction D2. At this time, the second welding step is performed in consideration of welding conditions, such as the melting points of the filler wire 30 and the electrode lead of the battery cell 10 and the arrangement state thereof.

In the second welding step, the filler wire 30a melted by welding may penetrate into the electrode lead of the battery cell 10 to a predetermined depth (refer to P2 of FIG. 6). Because the adhesion between the busbar 20 and the filler wire 30 is strengthened by the welding in the first welding step and the filler wire 30 is firstly pre-heated, the second welding step may not require an excessive amount of heat for welding.

Accordingly, in the second welding step, the filler wire 30 and the electrode lead may be welded under an appropriate condition, and infiltration of the laser beam LB into the battery cell 10 at the boundary between the filler wire 30 and the busbar 20 due to an excessive amount of heat may be prevented.

As described above, the present disclosure may perform the welding process in two steps and may individually apply the welding conditions for the respective steps, thereby preventing excessive heat input and laser infiltration. Thus, the present disclosure may improve workability and welding quality.

The filler wire 30 supplied in the filler wire supply step may be supplied to extend in the first direction D1 and may be formed such that the diameter 2r of the cross-section of the filler wire 30 in the direction perpendicular to the first direction D1 is equal to the size d of the insertion hole 21 in the second direction D2 within a machining error range.

Specifically, referring to FIGS. 3 and 4, the opposite end portions of the filler wire 30 in the second direction D2 may be brought into close contact with the busbar 20 because the diameter 2r of the cross-section of the filler wire 30 is equal to the width of the insertion hole 21, that is, the size d of the insertion hole 21 in the second direction D2. Accordingly, during laser welding, surface tension may act between the filler wire 30 and the bus bar 20 to the maximum in the shortest time in the molten state of the filler wire 30. Thus, welding quality may be improved.

Referring to FIG. 4, the filler wire 30 supplied in the filler wire supply step may be formed such that the radius r of the cross-section in the direction perpendicular to the first direction D1 is greater than or equal to the gap G.

Specifically, when the gap G is formed to be smaller than or equal to 0.5 times the diameter 2r in the direction perpendicular to the first direction D1 that is the extension direction of the filler wire 30, the filler wire 30 may be brought into close contact with the busbar 20 and the electrode lead by the surface tension to connect the busbar 20 and the electrode lead. Accordingly, a gap bridging effect may be obtained, and welding quality may be maintained constant.

In the first and second welding steps, a laser spot may be formed on at least one of the busbar 20, the battery cell 10, or the filler wire 30 by the laser beam LB.

In the first and second welding steps, the diameter of the laser spot may be formed in the range of ⅓ to 1 times the diameter 2r of the cross-section of the filler wire 30 in the direction perpendicular to the first direction D1.

Specifically, the laser spot may be formed on at least one (that is, a material to be welded) of the busbar 20, the battery cell 10, or the filler wire 30 depending on a laser welding process. A worker may determine the size of the filler wire 30 in consideration of the diameter of the laser spot formed by laser welding, thereby stably performing welding and securing welding quality.

For example, the diameter 2r of the vertical cross-section of the filler wire 30 may be formed in a size ranging from 1 to 3 times the diameter of the laser spot. However, the relationship between the diameter of the filler wire 30 and the diameter of the laser spot is not limited thereto and may be changed depending on a welding environment.

The length of the filler wire 30 in the first direction D1 may be calculated based on the required strength of a portion to be welded. Specifically, when welding strength required for a portion bonded by laser welding after the first and second welding steps is referred to as required welding strength, the length of the filler wire 30, which is supplied in the filler wire supply step, in the first direction D1 may be determined in consideration of the required welding strength.

That is, the length of the filler wire 30 may be determined to be a length by which more than the required welding strength is secured. For example, the length of the filler wire 30 in the first direction D1 may be 3 mm or more. However, the length of the filler wire 30 is not limited thereto and may be diversely changed depending on a welding environment, such as the size of the battery cell 10.

The first welding step may include performing laser welding such that the lateral portions of the filler wire 30 in the second direction D2 and the busbar 20 are bonded with each other.

Specifically, referring to FIG. 3, a plurality of filler wires 30 may be arranged in the first direction D1 when inserted into the insertion hole 21, and the opposite lateral portions in the second direction D2 may be brought into close contact with the busbar 20 (refer to portion A of FIG. 3). However, due to the nature of a process, it may be difficult to bring the filler wire 30 into close contact with the opposite ends of the insertion hole 21 in the first direction D1 when supplying the filler wire 30 (refer to portion B of FIG. 3).

Accordingly, in the first welding step, a laser beam is applied to the lateral portions of the filler wire 30 in the second direction D2 and is not applied to the ends of the filler wire 30 in the first direction D1. This is to prevent the laser beam from infiltrating into the battery cell 10 when the laser beam is applied to the ends of the filler wire 30 in the first direction D1 because the ends of the filler wire 30 in the first direction D1 are not brought into close contact with the busbar 20. Accordingly, the opposite ends of the filler wire 30 in the first direction D1 may not be exposed to the laser beam LB.

Referring to FIGS. 7A and 7B, the first welding step and the second welding step may include a process of performing welding in an oblique state in which the angle at which the laser beam LB is applied has a predetermined angle with respect to the direction in which the electrode lead and the busbar 20 are spaced apart from each other.

For example, in the first welding step, the opposite lateral portions of the filler wire 30 in the second direction D2 penetrate into the busbar 20 during laser welding. When the laser beam LB is applied in the oblique state, the amount by which the filler wire 30 penetrates into the busbar 20 may be changed depending on an inclination angle. Accordingly, in the first welding step, the amount of penetration may be adjusted by applying the laser beam LB in the oblique state.

In this case, the depth of penetration may be decreased, as compared with when the entire area of the filler wire 30 is molten and welded at one time by applying the laser beam LB to the center of the filler wire 30. Accordingly, when the depth of penetration needs to be adjusted during welding, the welding may be performed by obliquely applying the laser beam LB to the opposite lateral portions of the filler wire 30 in the second direction D2.

Referring to FIGS. 7A and 7B and FIGS. 8A and 8B, in the first welding step and the second welding step, the laser beam LB may be applied at different angles a plurality of times.

For example, in the first welding step, the laser beam LB may be applied to the opposite lateral portions of the filler wire 30 in the second direction D2 a plurality of times as described above (refer to FIGS. 7A and 7B) or may be applied at different angles θ1 and θ2 a plurality of times when one lateral portion of the filler wire 30 in the second direction D2 is welded(refer to FIGS. 7A and 7B). Accordingly, the welding depth may be adjusted in more detail.

Hereinafter, a laser welding method using filler wires 30 according to another aspect of the present disclosure will be described.

The laser welding method using the filler wires 30 according to the present disclosure relates to a battery module manufacturing method of welding upper plates and lower plates using the filler wires 30. The laser welding method using the filler wires 30 according to the present disclosure includes a first welding step and a second welding step.

The first welding step is a step of bonding the upper plates and the filler wires 30 by laser welding, and the second welding step is a step of bonding the lower plates and the filler wires 30 by laser welding after the first welding step.

For example, the laser welding method using the filler wires 30 according to the present disclosure may be used in the battery module manufacturing method. The upper plates may be the busbars 20, and the lower plates may be the electrode leads provided at the opposite ends of the battery cells 10. The laser welding method using the filler wires 30 according to the present disclosure may include all of the components of the above-described battery module manufacturing method within a technical range.

However, the laser welding method using the filler wires 30 according to the present disclosure is not limited to being used in the battery module manufacturing method and may be diversely applied to metal plates welded in a state of overlapping each other.

As described above, the present disclosure may perform the welding process in two steps to individually apply the welding conditions for the respective steps, thereby preventing excessive heat input and laser infiltration. Thus, the present disclosure may improve workability and welding quality.

According to the embodiments of the present disclosure, a deficiency in strength and a breakdown due to high brittleness that occur in existing butt joint welding or overlap joint welding may be improved. Thus, the stability of the battery module may be secured, and the performance thereof may be improved.

As described above, the present disclosure may perform the welding process in two steps to individually apply the welding conditions for the respective steps, thereby preventing excessive heat input and laser infiltration. Thus, the present disclosure may improve workability and welding quality.

The battery module manufacturing method according to the present disclosure may perform the laser welding in the state in which the insertion holes are previously formed in the busbars and the filler wires are inserted into the insertion holes, thereby minimizing infiltration of laser beams into the electrode leads of the battery cells and sufficiently securing the depth of penetration.

According to the embodiments of the present disclosure, the occurrence of the predetermined gaps between the busbars and the battery cells may be absorbed by performing welding using the filler wires, and thus welding quality may be maintained constant even without management of the gaps.

According to the embodiments of the present disclosure, a deficiency in strength and a breakdown due to high brittleness that occur in existing butt joint welding or overlap joint welding may be improved. Thus, the stability of the battery module may be secured, and the performance thereof may be improved.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

The present disclosure has been made to solve the above-mentioned problems occurring in the prior art while advantages achieved by the prior art are maintained intact.

An aspect of the present disclosure provides a battery module manufacturing method and a laser welding method using a filler wire for preventing excessive heat input and laser infiltration by individually applying welding conditions for respective steps by performing a welding process in two steps.

Another aspect of the present disclosure provides a battery module manufacturing method and a laser welding method using a filler wire for securing the stability of a battery module and improving the performance thereof by improving a deficiency in strength and a breakdown due to high brittleness that occur in existing butt joint welding or overlap joint welding.

Various embodiments of the present disclosure do not list all available combinations but are for describing a representative aspect of the present disclosure, and descriptions of various embodiments may be applied independently or may be applied through a combination of two or more.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of manufacturing a battery module comprising a busbar and an electrode lead included in a battery cell, the method comprising:
bonding the busbar and a filler wire by laser welding; and
bonding the electrode lead and the filler wire by laser welding after the bonding the busbar and the filler wire.

2. The method of claim 1, wherein the busbar and the electrode lead are formed of different metallic materials, and
wherein the filler wire is formed of a material different from those of the busbar and the electrode lead.

3. The method of claim 1, wherein prior to the bonding the busbar and the filler wire, the method further comprises:
preparing the busbar having at least one insertion hole formed therein;
superposing the busbar on the electrode lead included in the battery cell; and
supplying the filler wire such that the filler wire is inserted into the at least one insertion hole.

4. The method of claim 3, wherein preparing the busbar further comprises:
forming the at least one insertion hole in an area in which the busbar and the battery cell overlap each other, and
forming the at least one insertion hole in the busbar to extend in a first direction, and
wherein the at least one insertion hole comprises a plurality of insertion holes formed spaced apart from each other in a second direction crossing the first direction.

5. The method of claim 4, wherein supplying the filler wire further comprises:
supplying the filler wire to extend in the first direction, and
forming a diameter of a cross-section of the filler wire in a direction perpendicular to the first direction to be equal to a size of the insertion hole in the second direction within a machining error range.

6. The method of claim 4, wherein in the bonding the busbar and the filler wire, the laser welding is performed such that opposite lateral portions of the filler wire in the second direction are bonded to the busbar.

7. The method of claim 1, wherein in at least one of the bonding the busbar and the filler wire and the bonding the electrode lead and the filler wire, a laser beam is applied at different angles a plurality of times.

8. The method of claim 7, wherein in at least one of the bonding the busbar and the filler wire and the bonding the electrode lead and the filler wire, the welding is performed in an oblique state in which an angle at which the laser beam is applied has a predetermined angle with a direction in which the electrode lead and the busbar are spaced apart from each other.

9. A battery module manufacturing method for welding an upper plate and a lower plate, the method comprising:
bonding the upper plate and a filler wire by laser welding; and
bonding the lower plate and the filler wire by laser welding after the bonding the upper plate and the filler wire.
